(19) United States
(12) Patent Application Publication
(10) Pub. No.: US 2026/0163779 A1
(43) Pub. Date: Jun. 11, 2026

(54) ANTENNA PORT TABLES FOR PHYSICAL DOWNLINK SHARED CHANNEL (PDSCH) FOR UP TO 8 LAYERS

(71) Applicant: Telefonaktiebolaget LM Ericsson (publ), Stockholm (SE)

(72) Inventors: Andreas NILSSON, Göteberg (SE); Sven JACOBSSON, Västra Frölunda (SE); Jianwei ZHANG, Solna (SE); Per ERNSTRÖM, Stockholm (SE)

(21) Appl. No.: 19/124,049

(22) PCT Filed: Nov. 2, 2023
(86) PCT No.: PCT/IB2023/061088

§ 371 Date: Apr. 24, 2025

Related U.S. Application Data
(60) Provisional application No. 63/422,492, filed on Nov. 4, 2022.

(51) Int. Cl. H04L 27/26; H04L 5/00

(52) U.S. Cl. CPC H04L 27/261; H04L 5/0007; H04L 5/0044

(57) ABSTRACT

A method, network node and wireless device are disclosed. According to one aspect, a method in a network node configure to communicate with a wireless device (WD) includes determining a first code division multiplexing (CDM) group corresponding to super orthogonal antenna ports for which only the first WD is co-scheduled. The method also includes transmitting an indication of a codepoint of an antenna port field, the codepoint indicating an allocation of demodulation reference signal (DMRS) ports to the determined first CDM group, the indication indicating at least 5 physical downlink shared channel (PDSCH) layers.

### FIELD

The present disclosure relates to wireless communications, and in particular, to antenna port configurations for Physical Downlink Shared Channel (PDSCH) transmissions up to, for example, 8 layers.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also developing standards for Sixth Generation (6G) wireless communication networks

### NR Frame Structure and Resource Grid

Some existing NR systems use CP-OFDM (Cyclic Prefix Orthogonal Frequency domain Multiplexing) in both downlink (i.e., from a network node, gNB, or base station, to a user equipment (UE) or WD) and uplink (i.e., from WD to network node). DFT spread OFDM is also supported in the uplink. In the time domain, NR downlink and uplink may be organized into equally-sized subframes of 1 ms each. A subframe may be further divided into multiple slots of equal duration. The slot length depends on subcarrier spacing. For example, for subcarrier spacing of Δf=15 kHz, there may be only one slot per subframe where each slot includes 14 OFDM symbols.

Data scheduling in NR is typically on a slot basis where the first two symbols contain physical downlink control channel (PDCCH) and the remainder contains physical shared data channel, either physical downlink shared channel (PDSCH) or physical uplink shared channel (PUSCH). FIG. 1 is a timing diagram of an example NR time-domain structure with 15 kHz subcarrier spacing, which depicts an example slot configuration including a 14-symbol slot.

Different subcarrier spacing values may be supported in NR. The supported subcarrier spacing values (also referred to as different numerologies) are given by Δf=(15×2^{μ}) kHz where μ∈0,1,2,3,4. Δf=15 kHz is the basic subcarrier spacing. The slot durations at different subcarrier spacings is given by

$$\frac{1}{{2}^{μ}} ms .$$

In the frequency domain, a system bandwidth is divided into resource blocks (RBs), each corresponding to 12 contiguous subcarriers. The RBs are numbered starting with 0 from one end of the system bandwidth. One OFDM subcarrier during one OFDM symbol interval forms one resource element (RE). FIG. 2 is a graph which illustrates an example NR physical time-frequency resource grid, where only one resource block (RB) within a 14-symbol slot is shown.

Downlink (DL) PDSCH transmissions may be either dynamically scheduled, i.e., in each slot the network node/gNB transmits downlink control information (DCI) over PDCCH (Physical Downlink Control Channel) about which WD data is to be transmitted to and which RBs in the current downlink slot the data is transmitted on, or semi-persistently scheduled (SPS) in which periodic PDSCH transmissions are activated or deactivated by a DCI. Different DCI formats are defined in NR for DL PDSCH scheduling including, e.g., DCI format 1_0, DCI format 1_1, and DCI format 1_2.

Similarly, uplink (UL) PUSCH transmission may also be scheduled either dynamically or semi-persistently with uplink grants carried in PDCCH. NR supports two types of semi-persistent uplink transmission, i.e., type 1 configured grant (CG) and type 2 configured grant, where Type 1 configured grant is configured and activated by Radio Resource Control (RRC) while type 2 configured grant is configured by RRC but activated/deactivated by DCI. The DCI formats for scheduling PUSCH include, e.g., DCI format 0_0, DCI format 0_1, and DCI format 0_2.

### DMRS Configuration

Demodulation reference signals (DM-RS) may be used for coherent demodulation of physical layer data channels, i.e., Physical Downlink Shared Channel (PDSCH) and Physical Uplink Shared Channel (PUSCH), as well as of Physical Downlink Control Channel (PDCCH). The DM-RS may be confined to resource blocks carrying the associated physical layer channel and may be mapped on allocated resource elements of the time-frequency resource grid such that the receiver may efficiently handle time/frequency-selective fading of radio channels.

The mapping of DM-RS to resource elements may be configurable in both frequency and time domains. For example, in some existing systems, there are two mapping types in the frequency domain, i.e., type 1 and type 2. In addition, there are two mapping types in the time domain, i.e., mapping type A and type B, which define the symbol position of the first OFDM symbol containing DM-RS within a transmission interval.

The DM-RS mapping in the time domain may further be single-symbol based or double-symbol based, where the latter means that DM-RS is mapped in pairs of two adjacent OFDM symbols. For single symbol based DMRS, a WD may be configured with one, two, three, or four single-symbol DM-RS in a slot. For double-symbol based DMRS, a WD may be configured with one or two such double-symbol DM-RS in a slot. In scenarios with low Doppler, it may be sufficient to configure front-loaded DM-RS only, i.e., one single-symbol DM-RS or one double-symbol DM-RS, whereas in scenarios with high Doppler, additional DM-RS will be required in a slot.

FIG. 3 are graphs that show examples of type 1 and type 2 front-loaded DM-RS with single-symbol and double-symbol DM-RS and time domain mapping type A with first DM-RS in the third OFDM symbol of a transmission interval of 14 symbols. In FIGS. 3a-3d, type 1 and type 2 differ with respect to both the mapping structure and the number of supported DM-RS code division multiplexing (CDM) groups where type 1 support 2 CDM groups and Type 2 support 3 CDM groups

A DM-RS antenna port may be mapped to the resource elements within one CDM group only. For single-symbol DM-RS, two antenna ports may be mapped to each CDM group, whereas for double-symbol DM-RS four antenna ports may be mapped to each CDM group. Hence, for DM-RS type 1 the maximum number of DM-RS ports is four for a single-symbol based DMRS configuration and eight for double-symbol based DMRS configuration. For DM-RS type 2, the maximum number of DM-RS ports is six for a single-symbol based DMRS configuration and twelve for double-symbol based DMRS configuration.

For example, an orthogonal cover code (OCC) of length 2 (i.e., [+1, +1] or [+1, −1]) may be used to separate antenna ports mapped in the same two resource elements within a CDM group. The OCC may be applied in the frequency domain (FD) and/or in time domain (TD) when double-symbol DM-RS is configured. This is illustrated in FIG. 3 for CDM group 0, for example.

In NR Rel-15, the mapping of a PDSCH DM-RS sequence r(m), m=0, 1, . . . on antenna port p and subcarrier k in OFDM symbol l for the numerology index μ is specified in 3GPP TS 38.211 as:

$${a}_{k , l}^{( p , μ )} = {β}_{PUSCH}^{DMSR} {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 ,$$

where w_{f}(k′) represents a frequency domain length 2 OCC code and wₜ(l′) represents a time domain length 2 OCC code. Table 1 and Table 2 below list the PDSCH DM-RS mapping parameters for configuration type 1 and type 2, respectively.

TABLE 1
PDSCH DM-RS mapping parameters for configuration type 1.

| | | |
|---|---|---|
| CDM | w_{f} (k′) | wₜ (l′) |

| p | group λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 1 | +1 | +1 | +1 | +1 |
| 1003 | 1 | 1 | +1 | −1 | +1 | +1 |
| 1004 | 0 | 0 | +1 | +1 | +1 | −1 |
| 1005 | 0 | 0 | +1 | −1 | +1 | −1 |
| 1006 | 1 | 1 | +1 | +1 | +1 | −1 |
| 1007 | 1 | 1 | +1 | −1 | +1 | −1 |

TABLE 2
PDSCH DM-RS mapping parameters for configuration type 2.

| | | |
|---|---|---|
| CDM | w_{f} (k′) | wₜ (l′) |

| p | group λ | Δ | k′ = 0 | k′ = 1 | l′ = 0 | l′ = 1 |
|---|---|---|---|---|---|---|
| 1000 | 0 | 0 | +1 | +1 | +1 | +1 |
| 1001 | 0 | 0 | +1 | −1 | +1 | +1 |
| 1002 | 1 | 2 | +1 | +1 | +1 | +1 |
| 1003 | 1 | 2 | +1 | −1 | +1 | +1 |
| 1004 | 2 | 4 | +1 | +1 | +1 | +1 |
| 1005 | 2 | 4 | +1 | −1 | +1 | +1 |
| 1006 | 0 | 0 | +1 | +1 | +1 | −1 |
| 1007 | 0 | 0 | +1 | −1 | +1 | −1 |
| 1008 | 1 | 2 | +1 | +1 | +1 | −1 |
| 1009 | 1 | 2 | +1 | −1 | +1 | −1 |
| 1010 | 2 | 4 | +1 | +1 | +1 | −1 |
| 1011 | 2 | 4 | +1 | −1 | +1 | −1 |

For PDSCH mapping type A, DM-RS mapping is relative to slot boundary. That is, the first front-loaded DM-RS symbol in DM-RS mapping type A is in either the 3rd or 4th symbol of the slot. In addition to the front-loaded DM-RS, type A DM-RS mapping may consist of up to 3 additional DM-RS. If the scheduled PDSCH duration is shorter than the full slot, the positions of the DMRS changes according to the specification (i.e., 3GPP Technical Standard (TS) 38.211).

FIG. 4 is a timing diagram which illustrates examples of DM-RS configurations for PDSCH Mapping Type A. The example in FIG. 4 assumes that the PDSCH duration is the full slot. A PDSCH length of 14 symbols is assumed in the examples, although other symbol lengths may be utilized.

FIG. 5 is a timing diagram which illustrates examples of DM-RS configurations for PDSCH Mapping Type B. For PDSCH mapping type B, DM-RS mapping is relative to transmission start. That is, the first DM-RS symbol in DM-RS mapping type B is in the first symbol in which type B PDSCH starts.

The same DMRS design for PDSCH may also be applicable for PUSCH when transform precoding is not enabled, where the sequence r(m) may be mapped to the intermediate quantity

$${\tilde{a}}_{k , l}^{( {\tilde{p}}_{j} , μ )}$$

for DMRS port \tilde{p}ⱼ according to:

$${\tilde{a}}_{k , l}^{( {\tilde{p}}_{j} , μ )} = {w}_{f} ( {k}^{′} ) {w}_{t} ( {l}^{′} ) r ( 2 n + {k}^{′} )$$

$$k = \{ \begin{matrix}4 n + 2 {k}^{′} + Δ & Configuration type 1 \\ 6 n + {k}^{′} + Δ & Configuration type 2\end{matrix}$$

$${k}^{′} = 0 , 1$$

$$l = \overline{l} + {l}^{′}$$

$$n = 0 , 1 ,$$

$$j = 0 , 1 , … , υ - 1$$

where w_{f} (k′), wₜ(l′), and Δ are given by Tables 6.4.1.1.3-1 and 6.4.1.1.3-2 in 3GPP TS 38.211, which are reproduced below as Table 3 and Table 4, and ν is the number of PUSCH transmission layers. The intermediate quantity

$${\tilde{a}}_{k , l}^{( {\tilde{p}}_{j} , μ )} = 0$$

if Δ corresponds to any other antenna ports than \tilde{p}ⱼ.

The intermediate quantity

$${\tilde{a}}_{k , l}^{( {\tilde{p}}_{j} , μ )}$$

may be precoded, multiplied with the amplitude scaling factor

$${β}_{PUSCH}^{DMSR}$$

in order to conform to the transmit power specified in clause 6.2.2 of TS 38.214, and mapped to physical resources according to:

$$[ \begin{matrix}{a}_{k , l}^{{p}_{0} , μ} \\ ⋮ \\ {a}_{k , l}^{( {p}_{ρ - 1} , μ )}\end{matrix} ] = {β}_{PUSCH}^{DMRS} W [ \begin{matrix}{\tilde{a}}_{k , l}^{{\tilde{p}}_{0} , μ} \\ ⋮ \\ {\tilde{a}}_{k , l}^{( {\tilde{p}}_{υ - 1} , μ )}\end{matrix} ]$$

where
the precoding matrix W is given by clause 6.3.1.5 of TS38.211,
{p₀, . . . , p_{ρ-1}} is a set of physical antenna ports used for transmitting the PUSCH, and
{\tilde{p}₀, . . . , \tilde{p}_{ν-1}} is a set of DMRS ports for the PUSCH.

TABLE 3
Parameters for PUSCH DM-RS configuration type 1.

| | | |
|---|---|---|
| CDM | | |
| group | w_{f} (k′) | wₜ (l′) |

| \tilde{p} | λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 4
Parameters for PUSCH DM-RS configuration type 2.

| | | |
|---|---|---|
| CDM | | |
| group | w_{f} (k′) | wₜ (l′) |

| \tilde{p} | λ | Δ | k′ = 0 | k′=1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

### DMRS Sequence Generation

The DMRS sequence r(n) for both PDSCH and PUSCH is defined by

$$r ( n ) = \frac{1}{\sqrt{2}} ( 1 - 2 \cdot c ( 2 n ) ) + j \frac{1}{\sqrt{2}} ( 1 - 2 \cdot c ( 2 n + 1 ) ) .$$

where the pseudo-random sequence c(i) is defined in clause 5.2.1 of 3GPP TS 38.211. The pseudo-random sequence generator is initialized with

$${c}_{init} = ( {2}^{17} ( {N}_{symb}^{slot} {n}_{s , f}^{μ} + l + 1 ) ( 2 {N}_{ID}^{{\overline{n}}_{SCID}^{\overline{λ}}} + 1 ) + {2}^{17} ⌊ \frac{\overline{λ}}{2} ⌋ + 2 {N}_{ID}^{{\overline{n}}_{SCID}^{\overline{λ}}} + {\overline{n}}_{SCID}^{\overline{λ}} ) mod {2}^{31}$$

where l is the OFDM symbol number within the slot,

$${n}_{s , f}^{μ}$$

is the slot number within a frame, and:
For PDSCH DMRS,

$${N}_{ID}^{0} , {N}_{ID}^{1} ∈ \{ 0 , 1 , … , 65535 \}$$

are given by the higher-layer parameters scramblingID0 and scramblingID1, respectively, in the DMRS-DownlinkConfig IE if provided and the PDSCH is scheduled by PDCCH using DCI format 1_1 or 1_2 with the CRC scrambled by C-RNTI, MCS-C-RNTI, or CS-RNTI;
For PUSCH DMRS,

$${N}_{ID}^{0} , {N}_{ID}^{1} ∈ \{ 0 , 1 , … , 65535 \}$$

are given by the higher-layer parameters scramblingID0 and scramblingID1, respectively, in the DMRS-UplinkConfig IE if provided and the PUSCH is scheduled by DCI format 0_1 or 0_2, or by a PUSCH transmission with a configured grant;
For PDSCH DMRS,

$${N}_{ID}^{0} ∈ \{ 0 , 1 , … , 65535 \}$$

is given by the higher-layer parameter scramblingID0 in the DMRS-DownlinkConfig IE if provided and the PDSCH is scheduled by PDCCH using DCI format 1_0 with the CRC scrambled by C-RNTI, MCS-C-RNTI, or CS-RNTI;
For PUSCH DMRS,

$${N}_{ID}^{0} ∈ \{ 0 , 1 , … , 65535 \}$$

is given by the higher-layer parameter scramblingID0 in the DMRS-UplinkConfig IE if provided and the PUSCH is scheduled by DCI format 0_1 or 0_2, or by a PUSCH transmission with a configured grant;

$${N}_{ID}^{{\overline{n}}_{SCID}^{\overline{λ}}} = {N}_{ID}^{cell} otherwise ;$$

$${\overline{n}}_{SCID}^{\overline{λ}}$$

and λ̅ are given by:
   if the higher-layer parameter dmrs-Downlink in the DMRS-DownlinkConfig IE or dmrs-Uplink in the DMRS-UplinkConfig IE is provided, the corresponding

$${\overline{n}}_{SCID}^{\overline{λ}}$$

and λ̅ are determined as:

$${\overline{n}}_{SCID}^{\overline{λ}} = \{ \begin{matrix}{n}_{SCiD} & λ = 0 or λ = 2 \\ 1 - {n}_{SCID} & λ = 1\end{matrix}$$

$$\overline{λ} = λ$$

where λ is the CDM group index;
otherwise by:

$${\overline{n}}_{SCID}^{\overline{λ}} = {n}_{SCID}$$

$$\overline{λ} = 0$$

The quantity n_{SCID}∈{0, 1} is given by the DM-RS sequence initialization field, if present, in the DCI associated with the PDSCH transmission if DCI format 1_1 or 1_2 is used or the PUSCH transmission if DCI format 0_1 or 0_2 is used, or indicated by the higher layer parameter dmrs-SeqInitialization, if present, for a Type 1 PUSCH transmission with a configured grant; otherwise n_{SCID}=0.

### DMRS Ports Signaling

DMRS port(s) for a PDSCH or a PUSCH are signaled in the corresponding scheduling DCI. In addition to the DMRS ports, the number of CDM groups that are not allocated for PDSCH or PUSCH and also the number of front-loaded DMRS symbols are dynamically signaled in the DCI.

In PUSCH scheduling, the number of layers are indicated separately from DMRS ports signaling in the DCI. While for PDSCH scheduling, the number of layers and DMRS ports are signaled jointly in the DCI.

An “antenna port(s)” bit field in DCI is used the purpose. An example for type 1 DMRS with rank=1 and up to two maximum number of front-loaded DMRS OFDM symbols for PUSCH is shown in Table 5 and Table 6 below, which are copied from 3GPP TS 38.212. In this example, 4 bits are used. Note that DMRS type and maximum number of front-loaded DMRS symbols are semi-statically configured by RRC.

TABLE 5
Antenna port(s), transform precoder is disabled,
dmrs-Type = 1, maxLength = 2, rank = 1

| | Number of DMRS | | Number of |
|---|---|---|---|
| | CDM group(s) | DMRS | front-load |
| Value | without data | port(s) | symbols |
| 0 | 1 | 0 | 1 |
| 1 | 1 | 1 | 1 |
| 2 | 2 | 0 | 1 |
| 3 | 2 | 1 | 1 |
| 4 | 2 | 2 | 1 |
| 5 | 2 | 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14-15 | Reserved | Reserved | Reserved |

TABLE 6
Antenna port(s), transform precoder is disabled, dmrs-Type
= 1, maxLength = 2, rank = 2

| | Number of DMRS | | Number of |
|---|---|---|---|
| | CDM group(s) | DMRS | front-load |
| Value | without data | port(s) | symbols |
| 0 | 1 | 0, 1 | 1 |
| 1 | 2 | 0, 1 | 1 |
| 2 | 2 | 2, 3 | 1 |
| 3 | 2 | 0, 2 | 1 |
| 4 | 2 | 0, 1 | 2 |
| 5 | 2 | 2, 3 | 2 |
| 6 | 2 | 4, 5 | 2 |
| 7 | 2 | 6, 7 | 2 |
| 8 | 2 | 0, 4 | 2 |
| 9 | 2 | 2, 6 | 2 |
| 10-15 | Reserved | Reserved | Reserved |

Another example for type 1 DMRS with up to two maximum number of front-loaded DMRS OFDM symbols for PDSCH is shown in Table 7 below, which is copied from 3GPP TS 38.212.

TABLE 7
Antenna port(s) (1000 + DMRS port), dmrs-Type =
1, maxLength = 2 (from TS 38.212 of 3GPP)

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of | | | | of | | |
| | DMRS | | | | DMRS | | Number |
| | CDM | | Number | | CDM | | of |
| | group(s) | | of front- | | group(s) | | front- |
| | without | DMRS | load | | without | DMRS | load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

### DMRS Agreements in 3GPP Rel-18

In RAN1 #110-bis it was agreed that the Rel-18 DMRS will be using extended using FD-OCC length 4 instead of FD-OCC length 2 per CDM group. The FD-code will either be based on Walsh matrix (Hadamard code), as shown in the example of Table 8 below.

TABLE 8
Walsh matrix (Hadamard code) for length 4 FD-OCC

| FD-OCC | | | | |
|---|---|---|---|---|
| index | w_{f}(0) | w_{f}(1) | w_{f}(2) | w_{f}(3) |
| 0 | +1 | +1 | +1 | +1 |
| 1 | +1 | −1 | +1 | −1 |
| 2 | +1 | +1 | −1 | −1 |
| 3 | +1 | −1 | −1 | +1 |

Or, cyclic shifts may be configured with {0, π/2, π, 3π/2}, as shown in Table 9 below.

TABLE 9
Cyclic shifts with {0, π, π/2, 3π/2} for length 4 FD-OCC

| FD-OCC | | | | |
|---|---|---|---|---|
| index | w_{f}(0) | w_{f}(1) | w_{f}(2) | w_{f}(3) |
| 0 | +1 | +1 | +1 | +1 |
| 1 | +1 | −1 | +1 | −1 |
| 2 | +1 | +j | −1 | −i |
| 3 | +1 | −j | −1 | +j |

It was further agreed that the Rel-18 DMRS Ports that are identical with the Rel-15 DMRS ports should have the same antenna port number, while the new Rel-18 DMRS ports should use new antenna port numbers. This is illustrated in Table 10 and Table 11 below showing an agreement from RAN1 #110-bis for DMRS type 1 and DMRS type 2, respectively. Note that the code corresponding to the FD-OCC index may be seen in Table 8 and Table 9:

TABLE 10
Agreed antenna port numbers for Rel-18 DMRS for DMRS Type 1

| | CDM group | FD-OCC | TD-OCC |
|---|---|---|---|
| p | index | index | index |
| 0 | 0 | 0 | 0 |
| 1 | 0 | 1 | 0 |
| 2 | 1 | 0 | 0 |
| 3 | 1 | 1 | 0 |
| 4 | 0 | 0 | 1 |
| 5 | 0 | 1 | 1 |
| 6 | 1 | 0 | 1 |
| 7 | 1 | 1 | 1 |
| 8 | 0 | 2 | 0 |
| 9 | 0 | 3 | 0 |
| 10 | 1 | 2 | 0 |
| 11 | 1 | 3 | 0 |
| 12 | 0 | 2 | 1 |
| 13 | 0 | 3 | 1 |
| 14 | 1 | 2 | 1 |
| 15 | 1 | 3 | 1 |

TABLE 11
Agreed antenna port numbers for Rel-18 DMRS for
DMRS Type 2 Terminology on eType1 and eType2

| | CDM group | FD-OCC | TD-OCC |
|---|---|---|---|
| p | index | index | index |
| 0 | 0 | 0 | 0 |
| 1 | 0 | 1 | 0 |
| 2 | 1 | 0 | 0 |
| 3 | 1 | 1 | 0 |
| 4 | 2 | 0 | 0 |
| 5 | 2 | 1 | 0 |
| 6 | 0 | 0 | 1 |
| 7 | 0 | 1 | 1 |
| 8 | 1 | 0 | 1 |
| 9 | 1 | 1 | 1 |
| 10 | 2 | 0 | 1 |
| 11 | 2 | 1 | 1 |
| 12 | 0 | 2 | 0 |
| 13 | 0 | 3 | 0 |
| 14 | 1 | 2 | 0 |
| 15 | 1 | 3 | 0 |
| 16 | 2 | 2 | 0 |
| 17 | 2 | 3 | 0 |
| 18 | 0 | 2 | 1 |
| 19 | 0 | 3 | 1 |
| 20 | 1 | 2 | 1 |
| 21 | 1 | 3 | 1 |
| 22 | 2 | 2 | 1 |
| 23 | 2 | 3 | 1 |

3GPP discussions have considered terminology for Rel-18 DMRS, i.e., eType1 and eType2 DMRS ports, as follows:
For discussion purpose, example definitions of Rel.15 DMRS ports and Rel-18 DMRS ports are:
   Rel.15 Type 1/Type 2 DMRS ports: DMRS ports with FD-OCC length=2; and
   Rel.18 eType 1/eType 2 DMRS ports: DMRS ports with FD-OCC length>2.

FIG. 6 is a chart illustrating example differences between Rel.15 Type 1 DMRS ports and Rel.18 eType 1 DMRS ports.

In NR, antenna port tables for Rel.15 Type 1/Type 2 DMRS ports are specified. However, existing systems lack mechanisms for determining/selecting the antenna port tables in an effective way for Rel.18 eType 1/eType 2 DMRS ports.

### SUMMARY

Some embodiments advantageously provide methods, systems, and apparatuses for supporting antenna port configurations for PDSCH transmissions up to 8 layers.

For example, some embodiments provide methods, systems, and apparatuses for signaling, from the network node to the WD, the applied DMRS ports for a scheduled PDSCH transmission when the WD is configured with the extended number of orthogonal DMRS ports.

According to a first aspect of the present disclosure, a method of allocating Rel-18 DMRS antenna ports for PDSCH transmission is provided, where the method includes receiving an indication of a codepoint of an antenna port field in a DCI scheduling PDSCH indicating a number of PDSCH layers which corresponds to 5 spatial layers, 6 spatial layers, 7 spatial layers, or 8 spatial layers. The method further includes receiving DMRS ports (and/or receiving/transmitting DMRS via one or more configured ports) according to the indication of the codepoint of the antenna port field, i.e., a WD and/or network node may configure one or more ports to receive (and/or transmit) the DMRS based on the information in the indication.

According to one or more embodiments of this aspect, an additional indication is used to indicate if other WDs are co-scheduled with DMRS ports belonging to one or more of the CDM groups associated with the DMRS ports indicted for the WD.

According to one or more embodiments of this aspect, if 5 spatial layers is configured/indicated, then three DMRS ports are allocated to a first CDM group, and two DMRS ports are allocated to the second CDM group, and the two DMRS ports in the second CDM group are mutually super orthogonal.

According to one or more embodiments of this aspect, if 6 spatial layers is configured/indicated, then four DMRS ports are allocated to a first CDM group, and two DMRS ports are allocated to the second CDM group, and the two DMRS ports in the second CDM group are mutually super orthogonal.

According to one or more embodiments of this aspect, the number of CDM groups are minimized by utilizing FD-OCC combined with TD-OCC for double symbol DMRS.

Embodiments of the present disclosure may advantageously support antenna port (DMRS port) indication tables/configurations/indications which achieve improved robustness against delay spread and with improved orthogonality towards legacy DMRS ports, which in turn may increase the capacity and performance for DL SU/MU-MIMO, e.g., due to increased channel estimation quality and/or because more WDs may be served simultaneously while still maintaining a satisfactory DMRS channel estimation quality.

According to one aspect, a network node configured to communicate with a first wireless device, WD, is provided. The network node is configured to: determine a first code division multiplexing, CDM, group corresponding to super orthogonal antenna ports for which only the first WD is co-scheduled; and transmit an indication of a codepoint of an antenna port field, the codepoint indicating an allocation of demodulation reference signal, DMRS, ports to the determined first CDM group, the indication indicating at least 5 physical downlink shared channel, PDSCH, layers.

According to this aspect, in some embodiments, when the indication indicates 5 spatial layers, three DMRS ports are allocated to the first CDM group, and two DMRS ports being allocated to a second CDM group, the two DMRS ports in the second CDM group being mutually super orthogonal. In some embodiments, when the indication indicates 6 spatial layers, four DMRS ports are allocated to the first CDM group, and two DMRS ports are allocated to a second CDM group, the two DMRS ports in the second CDM group being mutually super orthogonal. In some embodiments, when the indication indicates 5-8 spatial layers, all the DMRS ports are allocated to the same CDM group. In some embodiments, when the indication indicates 5 layers, three layers are allocated to a first TD-OCC code, and two layers are allocated to a second TD-OCC code, the two DMRS ports in the second TD-OCC code being mutually super-orthogonal. In some embodiments, a number of CDM groups associated with a DMRS port configuration is determined WD a frequency domain orthogonal cover code (FD-OCC) configuration combined with an time domain orthogonal cover code (TD-OCC) configuration for double symbol DMRS.

According to another aspect, a method in a network node configured to communicate with a first wireless device, WD, is provided. The method includes: determining a first code division multiplexing, CDM, group corresponding to super orthogonal antenna ports for which only the first WD is co-scheduled; and transmitting an indication of a codepoint of an antenna port field, the codepoint indicating an allocation of demodulation reference signal, DMRS, ports to the determined first CDM group, the indication indicating at least 5 physical downlink shared channel, PDSCH, layers.

According to this aspect, in some embodiments, when the indication indicates 5 spatial layers, three DMRS ports are allocated to the first CDM group, and two DMRS ports being allocated to a second CDM group, the two DMRS ports in the second CDM group being mutually super orthogonal. In some embodiments, when the first indication indicates 6 spatial layers, four DMRS ports are allocated to the first CDM group, and two DMRS ports are allocated to a second CDM group, the two DMRS ports in the second CDM group being mutually super orthogonal. In some embodiments, when the indication indicates 5-8 spatial layers, all the DMRS ports are allocated to the same CDM group. In some embodiments, when the indication indicates 5 layers, three layers are allocated to a first TD-OCC code, and two layers are allocated to a second TD-OCC code, the two DMRS ports in the second TD-OCC code being mutually super-orthogonal. In some embodiments, a number of CDM groups associated with a DMRS port configuration is determined WD a frequency domain orthogonal cover code (FD-OCC) configuration combined with an time domain orthogonal cover code (TD-OCC) configuration for double symbol DMRS.

According to yet another aspect, a wireless device (WD) configured to communicate with a network node is provided. The WD is configured to: receive, from the network node, an indication of a codepoint of an antenna port field, the codepoint indicating an allocation of demodulation reference signal, DMRS, ports to at least a first code division multiplexing, CDM, group, the indication indicating at least 5 physical downlink shared channel, PDSCH, layers. The WD is also configured to determine a DMRS port configuration based on the codepoint and receive reference signaling according to the determined DMRS port configuration.

According to this aspect, in some embodiments, when the indication indicates 5 spatial layers, three DMRS ports are allocated to the first CDM group, and two DMRS ports being allocated to a second CDM group, the two DMRS ports in the second CDM group being mutually super orthogonal. In some embodiments, when the indication indicates 6 spatial layers, four DMRS ports are allocated to the first CDM group, and two DMRS ports are allocated to a second CDM group, the two DMRS ports in the second CDM group being mutually super orthogonal. In some embodiments, when the indication indicates 5-8 spatial layers, all the DMRS ports are allocated to the same CDM group. In some embodiments, when the indication indicates 5 layers, three layers are allocated to a first TD-OCC code, and two layers are allocated to a second TD-OCC code, the two DMRS ports in the second TD-OCC code being mutually super-orthogonal. In some embodiments, a number of CDM groups associated with a DMRS port configuration is determined WD a frequency domain orthogonal cover code (FD-OCC) configuration combined with an time domain orthogonal cover code (TD-OCC) configuration for double symbol DMRS.

According to another aspect, a method in a wireless device (WD) configured to communicate with a network node is provided. The method includes: receiving, from the network node, an indication of a codepoint of an antenna port field, the codepoint indicating an allocation of demodulation reference signal, DMRS, ports to at least a first code division multiplexing, CDM, group, the indication indicating at least 5 physical downlink shared channel, PDSCH, layers. The method includes determining a DMRS port configuration based on the codepoint; and receiving reference signaling according to the determined DMRS port configuration.

According to this aspect, in some embodiments, when the indication indicates 5 spatial layers, three DMRS ports are allocated to the first CDM group, and two DMRS ports being allocated to a second CDM group, the two DMRS ports in the second CDM group being mutually super orthogonal. In some embodiments, when the first indication indicates 6 spatial layers, four DMRS ports are allocated to the first CDM group, and two DMRS ports are allocated to a second CDM group, the two DMRS ports in the second CDM group being mutually super orthogonal. In some embodiments, when the indication indicates 5-8 spatial layers, all the DMRS ports are allocated to the same CDM group. In some embodiments, when the indication indicates 5 layers, three layers are allocated to a first TD-OCC code, and two layers are allocated to a second TD-OCC code, the two DMRS ports in the second TD-OCC code being mutually super-orthogonal. In some embodiments, wherein a number of CDM groups associated with a DMRS port configuration is determined WD a frequency domain orthogonal cover code (FD-OCC) configuration combined with an time domain orthogonal cover code (TD-OCC) configuration for double symbol DMRS.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a timing diagram of an example NR time-domain structure with 15 kHz subcarrier spacing;

FIG. 2 is a graph which illustrates an example NR physical time-frequency resource grid;

FIG. 3a-d is a graph which shows an example of type 1 and type 2 front-loaded DM-RS with single-symbol and double-symbol DM-RS and time domain mapping type A with first DM-RS in the third OFDM symbol of a transmission interval of 14 symbols;

FIG. 4 is a timing diagram which illustrates examples of DM-RS configurations for PDSCH Mapping Type A;

FIG. 5 is a timing diagram which illustrates examples of DM-RS configurations for PDSCH Mapping Type B;

FIG. 6 is a chart illustrating example differences between Rel.15 Type 1 DMRS ports and Rel.18 eType 1 DMRS ports;

FIG. 7 is a schematic diagram of an example network architecture illustrating a communication system connected via an intermediate network to a host computer according to the principles in the present disclosure;

FIG. 8 is a block diagram of a host computer communicating via a network node with a wireless device over an at least partially wireless connection according to some embodiments of the present disclosure;

FIG. 9 is a flowchart illustrating example methods implemented in a communication system including a host computer, a network node and a wireless device for executing a client application at a wireless device according to some embodiments of the present disclosure;

FIG. 10 is a flowchart illustrating example methods implemented in a communication system including a host computer, a network node and a wireless device for receiving user data at a wireless device according to some embodiments of the present disclosure;

FIG. 11 is a flowchart illustrating example methods implemented in a communication system including a host computer, a network node and a wireless device for receiving user data from the wireless device at a host computer according to some embodiments of the present disclosure;

FIG. 12 is a flowchart illustrating example methods implemented in a communication system including a host computer, a network node and a wireless device for receiving user data at a host computer according to some embodiments of the present disclosure;

FIG. 13 is a flowchart of an example process in a network node for supporting antenna port configurations for PDSCH transmissions up to 8 layers according to some embodiments of the present disclosure;

FIG. 14 is a flowchart of an example process in a wireless device for supporting antenna port configurations for PDSCH transmissions up to 8 layers according to some embodiments of the present disclosure;

FIG. 15 is a flowchart of an example process in a network node for supporting antenna port configurations for PDSCH transmissions up to 8 layers according to some embodiments of the present disclosure;

FIG. 16 is a flowchart of an example process in a wireless device for supporting antenna port configurations for PDSCH transmissions up to 8 layers according to some embodiments of the present disclosure;

FIG. 17 is a diagram which illustrates an example DMRS port numbering scheme according to some embodiments of the present disclosure;

FIG. 18 is a diagram which illustrates another example DMRS port numbering scheme according to some embodiments of the present disclosure;

FIG. 19 is a diagram which illustrates another example DMRS port numbering scheme according to some embodiments of the present disclosure;

FIG. 20 is a diagram which illustrates another example DMRS port numbering scheme according to some embodiments of the present disclosure;

FIG. 21 is a diagram which illustrates an example antenna port indication table for PDSCH rank 5 according to some embodiments of the present disclosure;

FIG. 22 is a diagram which illustrates another example antenna port indication table for PDSCH rank 5 according to some embodiments of the present disclosure;

FIG. 23 is a diagram which illustrates an example antenna port indication table for PDSCH rank 6 according to some embodiments of the present disclosure;

FIG. 24 is a diagram which illustrates an example antenna port indication table for PDSCH rank 7 according to some embodiments of the present disclosure; and

FIG. 25 is a diagram which illustrates an example antenna port indication table for PDSCH rank 8 according to some embodiments of the present disclosure.

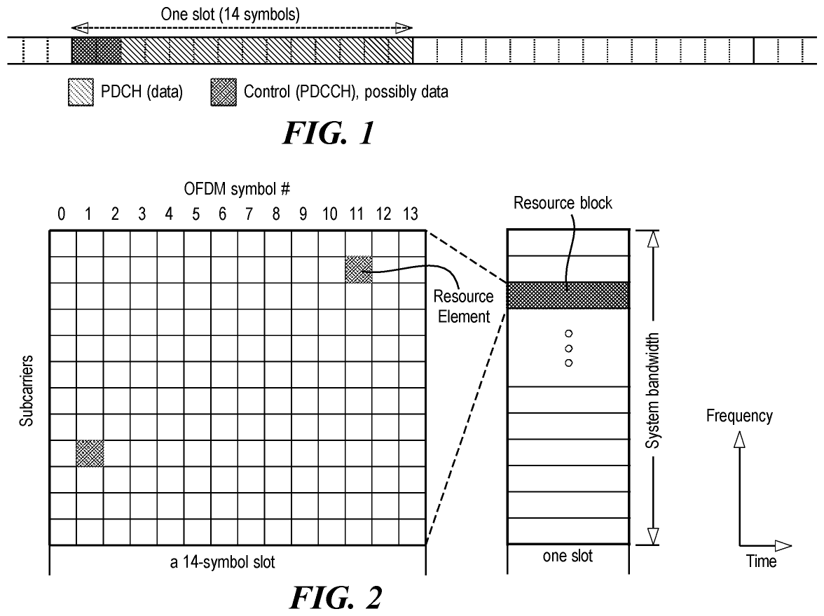

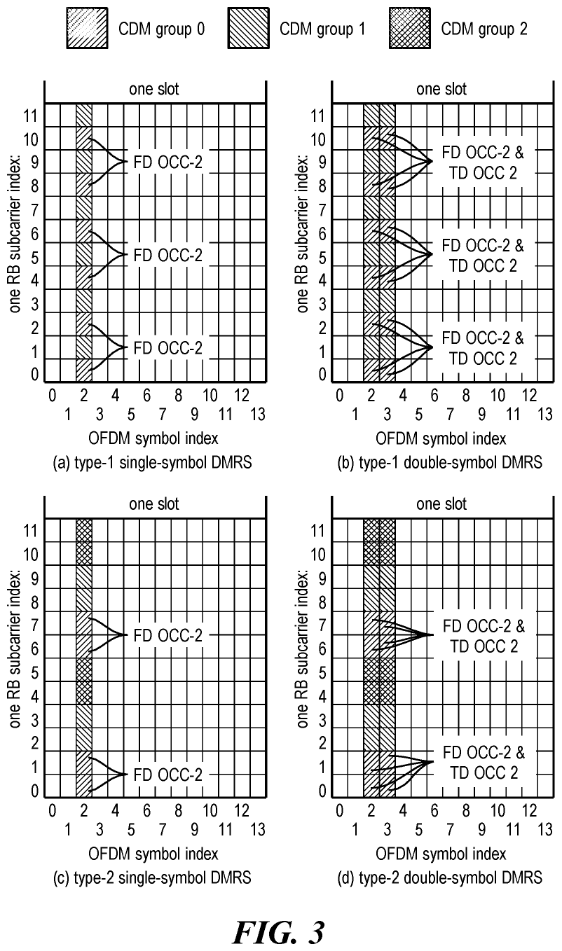

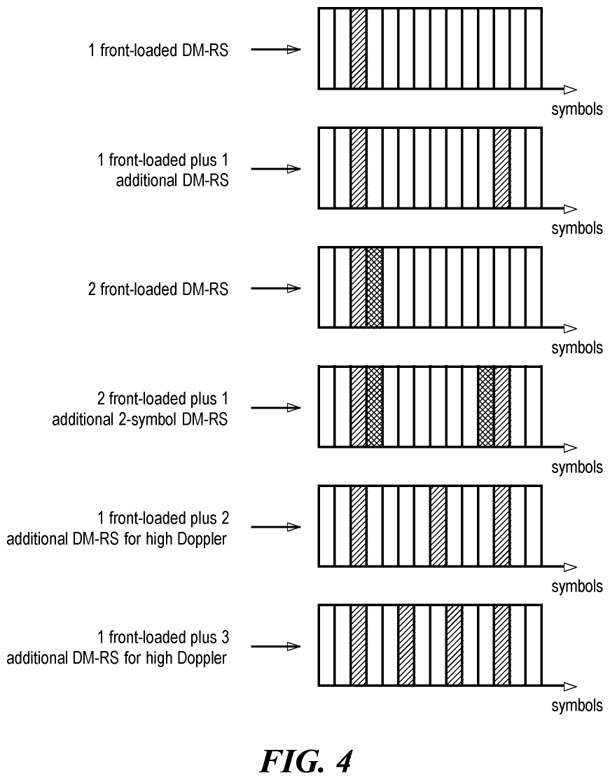

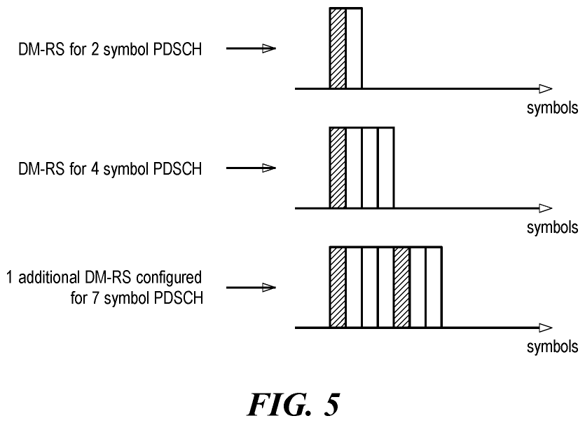

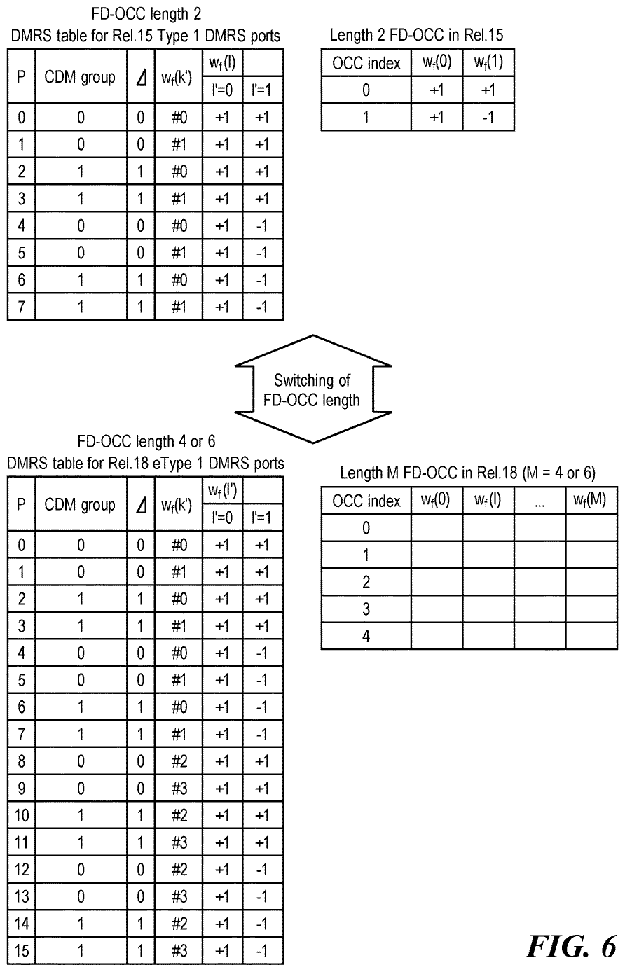

### DETAILED DESCRIPTION

Before describing in detail example embodiments, it is noted that the embodiments reside primarily in combinations of apparatus components and processing steps related to supporting antenna port configurations for PDSCH transmissions up to 8 layers. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the term “table” is used, which may refer to any one of a data structure, indication, configuration, assignment, etc. In some embodiments, the table includes information fields, bit fields, etc., and may be organized, e.g., in a two-dimensional (or generally, N-dimensional) manner, such as according to rows and columns. The table (and/or data structure, indication, configuration, assignment, etc.) may be signaled in one or more network node or WD transmissions/messages/etc., and/or may be preconfigured in the network node and/or WD.

In some embodiments, the term “DMRS” (or DM-RS) is used, which may refer to signaling such as reference signal(s) used for demodulation. For example, DMRS may be used to estimate a radio channel and/or beamformed and/or associated with a resource and/or a code division multiplexing (CDM) group. DMRS may be transmitted and/or received in uplink and/or downlink. A DMRS may be associated with and/or correspond to a port (e.g., antenna port, physical port, logical port, etc.). For example, a network node and/or WD may be configured with one or more antennas, e.g., where at least one of the antennas comprises a physical/logical port which may be mapped to and/or correspond to a DMRS port.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide configurations for supporting antenna port configurations for PDSCH transmissions up to 8 layers.

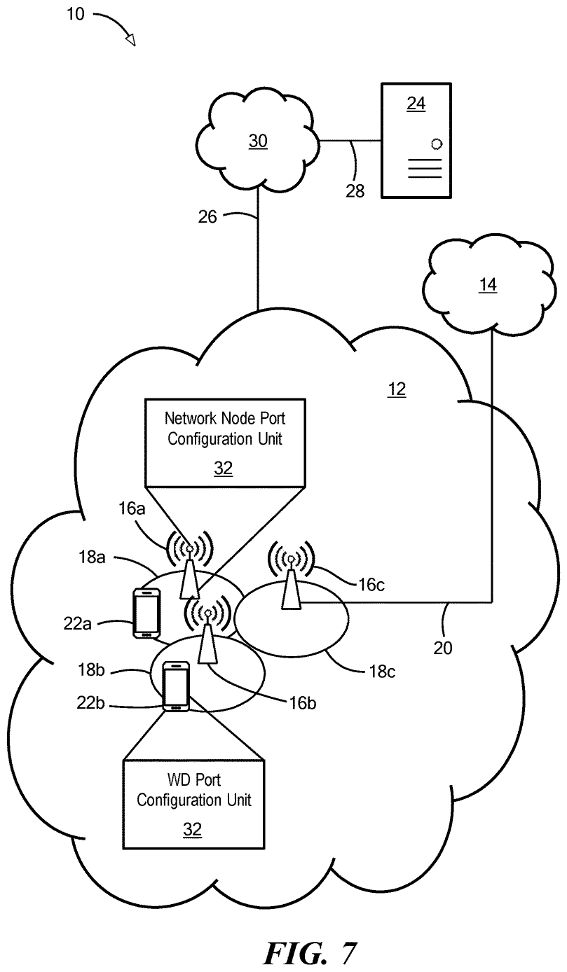

Returning now to the drawing figures, in which like elements are referred to by like reference numerals, there is shown in FIG. 7 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 7 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a network node port configuration unit 32 which is configured to support antenna port configurations for PDSCH transmissions up to 8 layers. A wireless device 22 is configured to include a WD port configuration unit 34 which is configured to support antenna port configurations for PDSCH transmissions up to 8 layers.

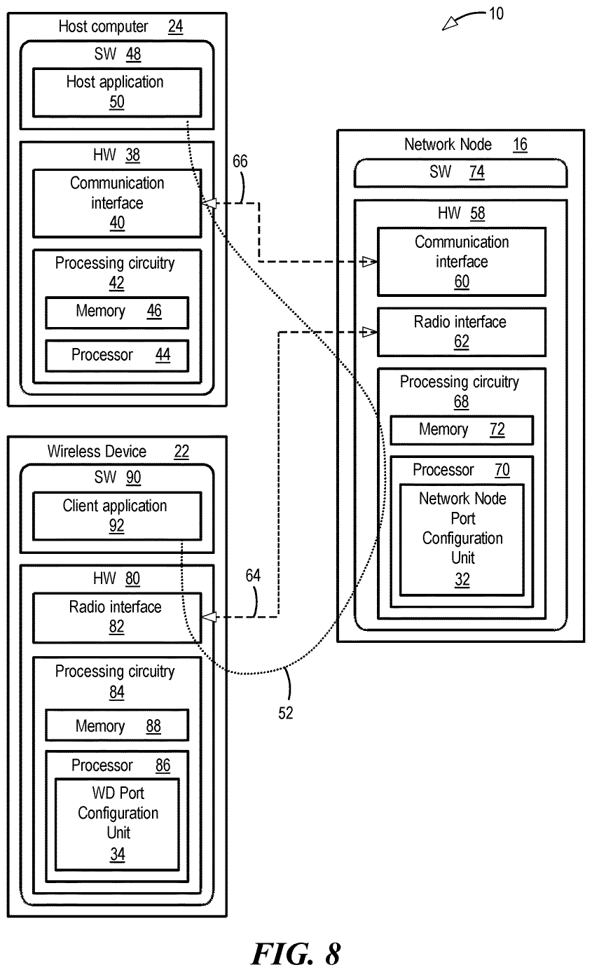

Example implementations, in accordance with an embodiment, of the WD 22, network node 16 and host computer 24 discussed in the preceding paragraphs will now be described with reference to FIG. 8. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Arrays) and/or ASICs (Application Specific Integrated Circuitry/Circuits) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include network node port configuration unit 32 configured for supporting antenna port configurations for PDSCH transmissions up to 8 layers.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22

In some embodiments, the inner workings of the network node 16, WD 22, and host computer 24 may be as shown in FIG. 8 and independently, the surrounding network topology may be that of FIG. 7.

In FIG. 8, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 7 and 8 show various “units” such as network node port configuration unit 32, and WD port configuration unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

FIG. 9 is a flowchart illustrating an example method implemented in a communication system, such as, for example, the communication system of FIGS. 7 and 8, in accordance with one embodiment. The communication system may include a host computer 24, a network node 16 and a WD 22, which may be those described with reference to FIG. 8. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

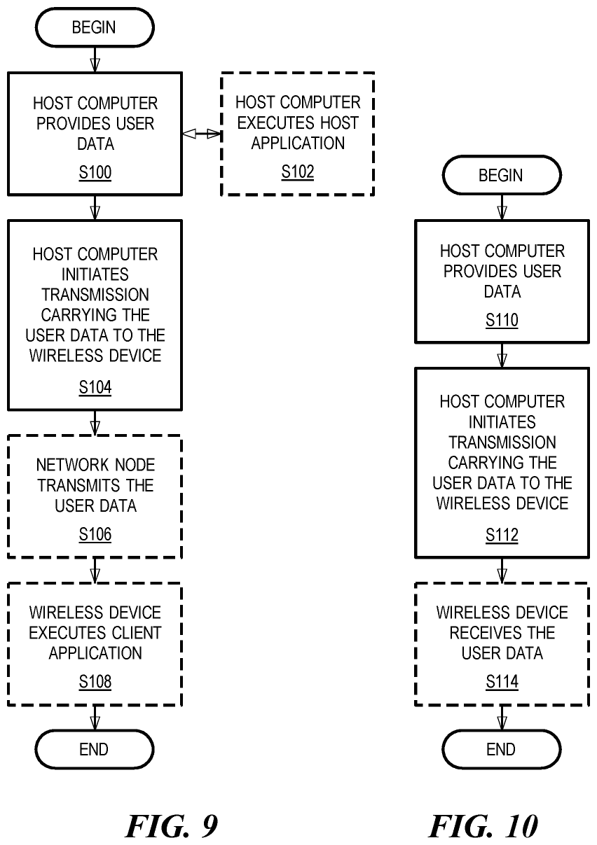

FIG. 10 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

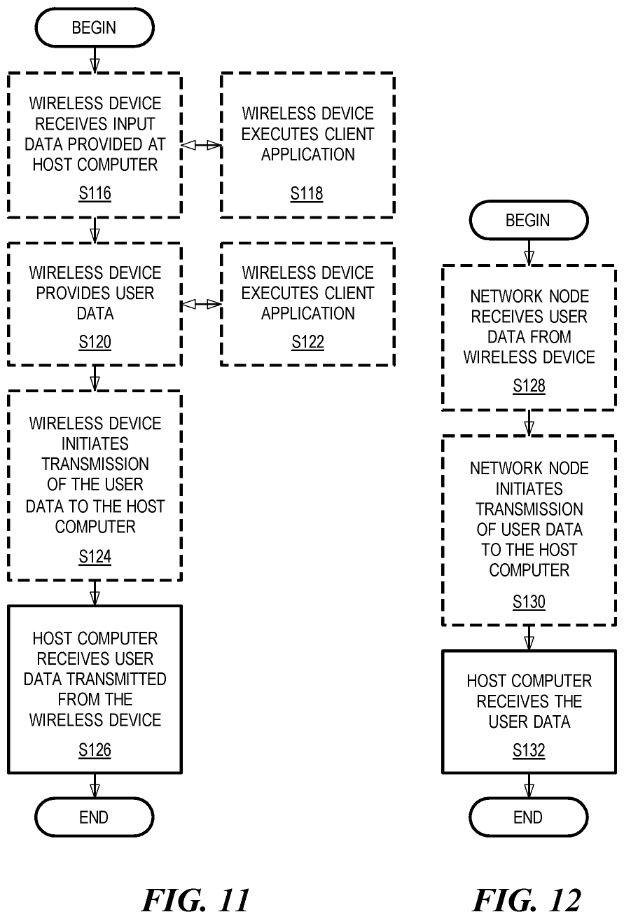

FIG. 11 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 12 is a flowchart illustrating an example method implemented in a communication system, such as, for example, the communication system of FIG. 7, in accordance with one embodiment. The communication system may include a host computer 24, a network node 16 and a WD 22, which may be those described with reference to FIGS. 7 and 8. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

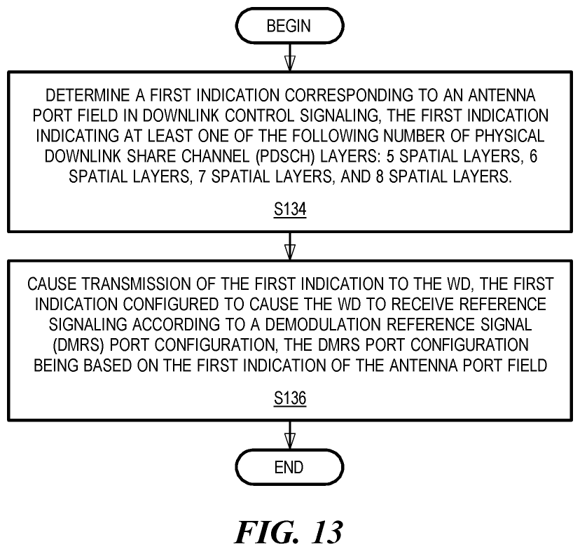

FIG. 13 is a flowchart of an example process in a network node 16 for supporting antenna port configurations for PDSCH transmissions up to 8 layers. One or more blocks described herein may be performed by one or more elements of network node 16 such as by one or more of processing circuitry 68 (including the network node port configuration unit 32), processor 70, radio interface 62 and/or communication interface 60. Network node 16 is configured to determine (Block S134) a first indication corresponding to an antenna port field in downlink control signaling, the first indication indicating at least one of the following number of physical downlink share channel (PDSCH) layers: 5 spatial layers, 6 spatial layers, 7 spatial layers, and 8 spatial layers. Network node 16 is configured to cause transmission (Block S136) of the first indication to the WD 22, where the first indication is configured to cause the WD 22 to receive reference signaling (e.g., demodulation reference signaling) according to a demodulation reference signal (DMRS) port configuration, where the DMRS port configuration is based on the first indication of the antenna port field.

In one or more embodiments, the network node 16 is further configured to determine a second indication indicating at least one other WD 22 is co-scheduled with DMRS ports belonging to at least one code division multiplexing (CDM) group associated with the DMRS ports indicated for the WD 22, and cause transmission of the second indication to the WD.

In one or more embodiments, when the first indication indicates 5 spatial layers, the DMRS port configuration includes three DMRS ports allocated to a first CDM group, two DMRS ports allocated to a second CDM group, where the two DMRS ports in the second CDM group are mutually super orthogonal.

In one or more embodiments, when the first indication indicates 6 spatial layers, the DMRS port configuration includes four DMRS ports allocated to a first CDM group, two DMRS ports allocated to a second CDM group, where the two DMRS ports in the second CDM group are mutually super orthogonal

In one or more embodiments, a number of CDM groups associated with the DMRS port configuration is determined based on an frequency domain orthogonal cover code (FD-OCC) configuration combined with an time domain orthogonal cover code (TD-OCC) configuration for double symbol DMRS.

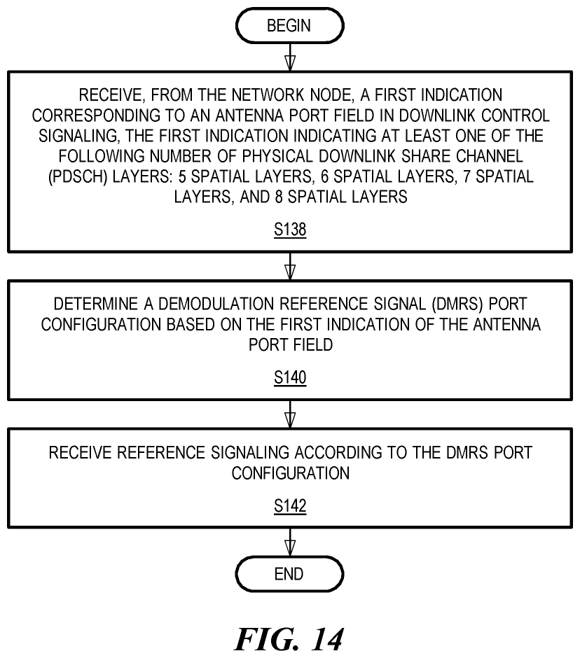

FIG. 14 is a flowchart of an example process in a wireless device 22 according to some embodiments of the present disclosure for supporting antenna port configurations for PDSCH transmissions up to 8 layers. One or more blocks described herein may be performed by one or more elements of wireless device 22 such as by one or more of processing circuitry 84 (including the WD port configuration unit 34), processor 86, radio interface 82 and/or communication interface 60. Wireless device 22 is configured to receive (Block S138), from the network node 16, a first indication corresponding to an antenna port field in downlink control signaling, where the first indication indicates at least one of the following number of physical downlink share channel (PDSCH) layers: 5 spatial layers, 6 spatial layers, 7 spatial layers, and 8 spatial layers. WD 22 is configured to determine (Block S140) a demodulation reference signal (DMRS) port configuration based on the first indication of the antenna port field. WD 22 is configured to receive (Block S142) reference signaling (e.g., transmitted by network node 16) according to the DMRS port configuration.

In one or more embodiments, the WD 22 is further configured to receive a second indication indicating at least one other WD 22 is co-scheduled with DMRS ports belonging to at least one code division multiplexing (CDM) group associated with the DMRS ports indicated for the WD 22, the determining of the DMRS port configuration is further based on the second indication.

In one or more embodiments, the first indication indicates 5 spatial layers, the DMRS port configuration includes three DMRS ports allocated to a first CDM group, two DMRS ports allocated to a second CDM group, where the two DMRS ports in the second CDM group are mutually super orthogonal.

In one or more embodiments, the first indication indicates 6 spatial layers, the DMRS port configuration includes four DMRS ports allocated to a first CDM group, and two DMRS ports allocated to a second CDM group, where the two DMRS ports in the second CDM group are mutually super orthogonal

In one or more embodiments, a number of CDM groups associated with the DMRS port configuration is determined based on a frequency domain orthogonal cover code (FD-OCC) configuration combined with an time domain orthogonal cover code (TD-OCC) configuration for double symbol DMRS.

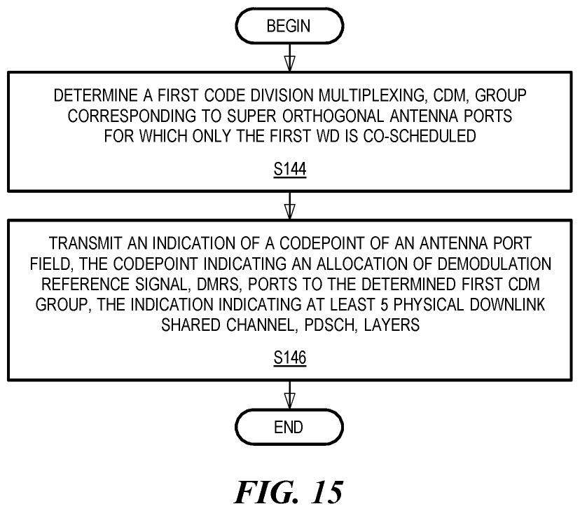

FIG. 15 is a flowchart of an example process in a network node 16 for supporting antenna port configurations for PDSCH transmissions up to 8 layers. One or more blocks described herein may be performed by one or more elements of network node 16 such as by one or more of processing circuitry 68 (including the network node port configuration unit 32), processor 70, radio interface 62 and/or communication interface 60. Network node 16 is configured to determine a first code division multiplexing, CDM, group corresponding to super orthogonal antenna ports for which only the first WD 22 is co-scheduled (Block S144). The process also includes transmitting an indication of a codepoint of an antenna port field, the codepoint indicating an allocation of demodulation reference signal, DMRS, ports to the determined first CDM group, the indication indicating at least 5 physical downlink shared channel, PDSCH, layers (Block S146).

According to this aspect, in some embodiments, when the indication indicates 5 spatial layers, three DMRS ports are allocated to the first CDM group, and two DMRS ports being allocated to a second CDM group, the two DMRS ports in the second CDM group being mutually super orthogonal. In some embodiments, when the indication indicates 6 spatial layers, four DMRS ports are allocated to the first CDM group, and two DMRS ports are allocated to a second CDM group, the two DMRS ports in the second CDM group being mutually super orthogonal. In some embodiments, when the indication indicates 5-8 spatial layers, all the DMRS ports are allocated to the same CDM group. In some embodiments, when the indication indicates 5 layers, three layers are allocated to a first TD-OCC code, and two layers are allocated to a second TD-OCC code, the two DMRS ports in the second TD-OCC code being mutually super-orthogonal. In some embodiments, a number of CDM groups associated with a DMRS port configuration is determined WD 22 a frequency domain orthogonal cover code (FD-OCC) configuration combined with an time domain orthogonal cover code (TD-OCC) configuration for double symbol DMRS.

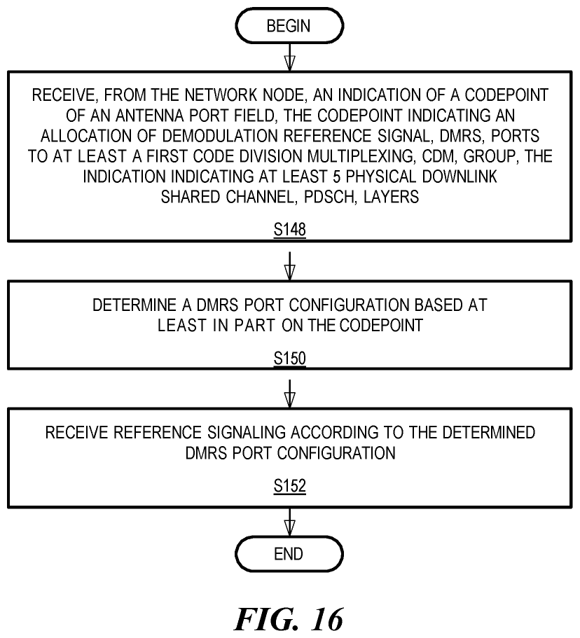

FIG. 16 is a flowchart of an example process in a wireless device 22 according to some embodiments of the present disclosure for supporting antenna port configurations for PDSCH transmissions up to 8 layers. One or more blocks described herein may be performed by one or more elements of wireless device 22 such as by one or more of processing circuitry 84 (including the WD port configuration unit 34), processor 86, radio interface 82 and/or communication interface 60. Wireless device 22 is configured to receive, from the network node 16, an indication of a codepoint of an antenna port field, the codepoint indicating an allocation of demodulation reference signal, DMRS, ports to at least a first code division multiplexing, CDM, group, the indication indicating at least 5 physical downlink shared channel, PDSCH, layers (Block S148). The process also includes determining a DMRS port configuration based on the codepoint (Block S150). The process further includes receiving reference signaling according to the determined DMRS port configuration (Block S152).

According to this aspect, in some embodiments, when the indication indicates 5 spatial layers, three DMRS ports are allocated to the first CDM group, and two DMRS ports being allocated to a second CDM group, the two DMRS ports in the second CDM group being mutually super orthogonal. In some embodiments, when the first indication indicates 6 spatial layers, four DMRS ports are allocated to the first CDM group, and two DMRS ports are allocated to a second CDM group, the two DMRS ports in the second CDM group being mutually super orthogonal. In some embodiments, when the indication indicates 5-8 spatial layers, all the DMRS ports are allocated to the same CDM group. In some embodiments, when the indication indicates 5 layers, three layers are allocated to a first TD-OCC code, and two layers are allocated to a second TD-OCC code, the two DMRS ports in the second TD-OCC code being mutually super-orthogonal. In some embodiments, wherein a number of CDM groups associated with a DMRS port configuration is determined WD 22 a frequency domain orthogonal cover code (FD-OCC) configuration combined with an time domain orthogonal cover code (TD-OCC) configuration for double symbol DMRS.

Having described the general process flow of arrangements of the disclosure and having provided examples of hardware and software arrangements for implementing the processes and functions of the disclosure, the sections below provide details and examples of arrangements for supporting antenna port configurations for PDSCH transmissions up to 8 layers.

One or more network node 16 functions described below may be performed by one or more of processing circuitry 68, processor 70, network node port configuration unit 32, etc. One or more wireless device 22 functions described below may be performed by one or more of processing circuitry 84, processor 84, WD port configuration unit 34, etc.

In some embodiments of the present disclosure, the WD 22 may be implemented with a future Rel-18 DMRS port extension framework for Type 1 DMRS and/or Type 2 DMRS, and where the number of code division multiplexing (CDM) groups remains the same as in NR rel-15 (i.e. 2 CDM groups for Type 1 DMRS and 3 CDM groups for type 2 DRMS), and where increased number of orthogonal frequency codes are used per CDM group to extend the number of DMRS ports. For example, the FD-OCC code length may be increased from 2 to 4 per CDM group (however other frequency coding techniques may be used also, for example cyclic shifts may be introduced with different sequence lengths).

First, the following definition is made:

Definition: If two orthogonal vectors

$${v}_{1} = [ \begin{matrix}{v}_{1 , 1} \\ … \\ {v}_{1 , K}\end{matrix} ] and {v}_{2} = [ \begin{matrix}{v}_{2 , 1} \\ … \\ {v}_{2 , K}\end{matrix} ] ( {v}_{1}^{H} {v}_{2} = 0 )$$

of sequence length N are orthogonal over every K sequence parts of length N′<N (where N=N′*K), i.e.,

$${v}_{1 , i}^{H} {v}_{2 , i} = 0 , i = 1 , … , K ,$$

the vectors v₁ and v₂ are said to be super-orthogonal.

For example, the vectors of orthogonal cover codes [1 1 1 1] and [1 −1 1 −1] of length four are super-orthogonal as they are also orthogonal over the partial length two ([1 1] and [1 −1]).

The property of super-orthogonality between some DMRS ports and the relation to other (e.g., legacy Rel-15) DMRS ports is utilized in the present disclosure. In DMRS port index table, Table 10:, for eType1 the first 8 rows (ports) are using same FD-OCC as Rel-15 legacy Type1 table, those ports (p0-p7 for PUSCH and p1000-p1007 for PDSCH) are referred to as Rel-15 Type1 ports in the following description. Similar to the example of Table 12, eType2, the first 12 ports are using same FD-OCC as Rel-15 legacy Type2 table, those ports (p0-p11 for PUSCH and p1000-p1011 for PDSCH) are referred to as Rel-15 Type2 ports.

In some embodiments, for a receiver to perform channel estimation using multiple DMRS ports (for example a rank 2 reception of 2 ports), it may be beneficial if super-orthogonal DMRS ports are used for the two layers compared to if “only” orthogonal ports are used.

This benefit may be explained if time domain channel estimation algorithms are used, where a domain transform (such as a DFT) is used on the received DMRS. Two super-orthogonal ports have a larger sample (i.e., time) separation after the transform compared to two non-super orthogonal ports and this is a potentially useful property if there is a delay in channel which introduce cross interference between two DMRS ports. To maximize the robustness against channel delays, super-orthogonal DMRS ports may be used, or equivalently, the cyclic shifts of the DMRS port sequences in time domain may be maximized.

Alternatively, if frequency domain channel estimation algorithms are used, the shorter sequence length N′ to obtain orthogonality between super-orthogonal ports implies that the channel estimator may operate on N′ samples at a time instead of N>N′ samples, which makes the system less vulnerable to delay spread/frequency selectivity. The improved channel estimation performance will improve the user throughput, especially for higher order modulation and higher code rates, over existing systems and solutions.

The following principles may form the basis for the creating of (efficient/robust/etc.) antenna port indication tables (and/or assignments/configurations/indications/etc.) for UL (and/or DL) transmission (e.g., for PUSCH DMRS ports).
DMRS ports may ideally be assigned to a WD 22 are using super-orthogonal ports when possible; and/or
Ideally use as few CDM groups as possible (e.g., for double symbol DMRS), e.g., to allow PUSCH rate matching around DMRS subcarriers.
   Port Numbering for DMRS eType 1 and eType 2

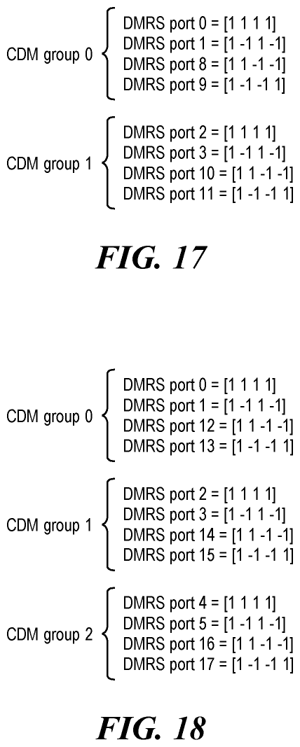

In the present disclosure, it may be assumed that the following DMRS port number definitions apply for Type 1 DMRS with single DMRS symbol for the Rel-18 WDs, as illustrated in FIG. 17, which depicts an example DMRS port numbering scheme according to embodiments of the present disclosure for DMRS type 1 using hadamard code. Here, it may be seen that DMRS port 0 & DMRS port 1 are mutually super-orthogonal with each other, which also is the case for DMRS port 8 & DMRS port 9, for DMRS port 2 & DMRS port 3 and for DMRS port 10 & DMRS port 11.

By this definition, it may be seen that DMRS port 0 & 1 are the same as the DMRS port 0 & 1 of the legacy Rel-15 DMRS ports, assuming the same DMRS sequences are re-used for DMRS Rel-18 as was used for DMRS Rel-15. It may also be seen that DMRS port 2 & 3 is the same as the DMRS port 2 & 3 of the legacy Rel-15 DMRS ports, assuming the same DMRS sequences are re-used for DMRS Rel-18 as was used for DMRS Rel-15/16.

FIG. 18 illustrates an example DMRS port numbering assumed according to some embodiments of the present disclosure for DMRS type 2 using hadamard code (according to agreements from RAN1 #110 bis). Note that the cyclic shift code may be exchanged to the hadamard code depending on what gets specified in the end. FIG. 18 illustrates the corresponding port numbers for DMRS type 2.

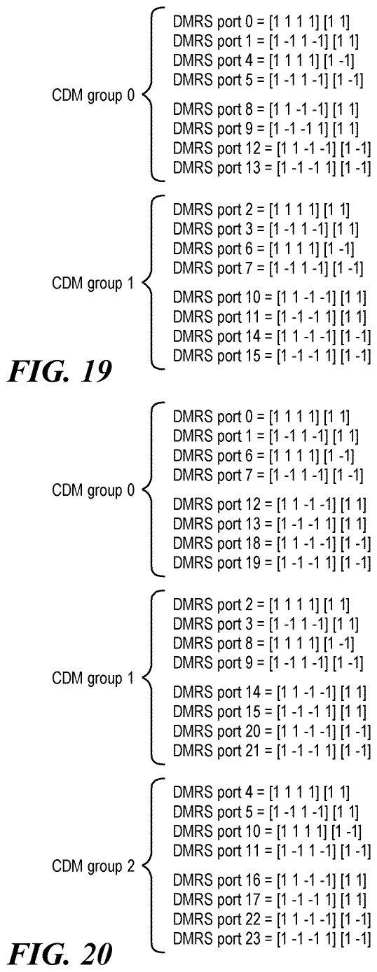

FIG. 19 illustrates an example DMRS ports numbering scheme for eType1 DMRS with 2 front-loaded symbols, according to some embodiments of the present disclosure. For each DMRS port, 2 vectors are used where a first vector showing an example with Hadamard FD-OCC code and the second vector showing the TD-OCC code applied on consecutive DMRS symbols. Note that instead of [1 1] and [1-1] used in this example, the TD-OCC code may be [1, j] or [1, −j] for ports number 8-15. In FIG. 19, an example DMRS port numbering for DMRS type 1 with 2 front-loaded symbols using Hadamard code is shown.

FIG. 20 illustrates another example DMRS port numbering configuration according to some embodiments of the present disclosure for DMRS type 1 with 2 front-loaded symbols using Hadamard code.

When scheduling the WD 22, the network node 16 may indicate (e.g., in the DCI) which antenna (DMRS) ports the WD 22 may assume/configure/determine/select/etc. for PDSCH reception. Such an indication may point to a row in an antenna port indication table. The row determination/selection may be made in the network node 16 (e.g., gNB) scheduler by taking into account e.g., channel estimation performance, whether data is FDM or TDM with the DMRS, whether this is a SU or MU-MIMO scheduling, etc.

One consideration when designing the DL antenna port tables is to ensure that the DMRS ports scheduled simultaneously are, if possible, super-orthogonal to each other when received by the WD 22, to minimize the inter DMRS port interference. Hence, in one embodiment, the antenna port indication table contains rows where the DMRS port separated by coding (OCC) within each CDM group and that are scheduled simultaneously are super-orthogonal (for realistic TRP-UE channel realizations). However, for the WD 22 to utilize this, the WD 22 may need to know whether other WDs 22 are scheduled on DMRS ports in the same CDM group, hence in some embodiment, additional indications are used to indicate to the WD if one or more of the CDM groups used for that WD 22 also is used by other WDs 22 simultaneously.

### Example Embodiments of Antenna Port Indication Tables for 5 PDSCH Layers

Some example embodiments for DMRS type 1 are illustrated in the example table illustrated in FIG. 21, in this example, for rank 5, where the rows X to X+1 is using a single (front loaded) DMRS symbol, and rows X+3 to X+5 is using two (front loaded) DMRS symbols.

Referring to FIG. 21, in the row associated with codepoint value X and X+1 (single front loaded DMRS symbol), three DMRS ports are allocated to a first CDM group, and two DMRS ports are allocated to the second CDM group, and where the two DMRS ports in the second CDM group are mutually super orthogonal.

Referring still to FIG. 21, in the row associated with codepoint X+2 and X+3 (double front loaded DMRS symbol), only a single CDM group (CDM group 0) is used for all 5 ports, which reduce the number of CDM groups the WD 22 has to perform channel estimation for (thus saving WD 22 complexity and/or WD 22 energy), as well as enabling the possibility to transmit PDSCH on Res associated with CDM group1, which may increase the DL user throughput (i.e. when using only a single CDM group PDSCH may be rate matched around the Res associated with the single CDM group, which gives more Res for PDSCH compared to if two CDM groups are used and the PDSCH must be rate-matched around both CDM groups). In the row associated with codepoint X+4, all 5 ports are also allocated to one CDM group, but CDM group 1 instead of CDM group 2.

In some embodiments, in order for the WD 22 to be able to make use of the super-orthogonality property for the described port combinations, the WD 22 may need to know that no other WD 22 has been co-scheduled on ports of the same CDM-group but that are not super-orthogonal to the ports of the first WD. The rows (or codepoints) in the tables may therefore be supplemented with a scheduling assumption. Such a scheduling assumption may be formulated, e.g., in some embodiments, the WD 22 may assume that no port based on the CDM groups corresponding to the antenna ports indicated by the codepoint X in the Antenna ports field in DCI is utilized for any co-scheduled WD.

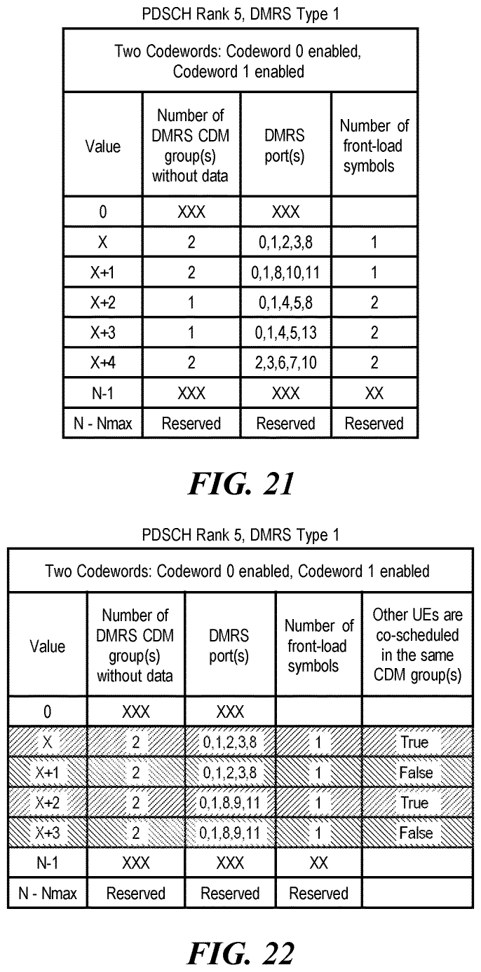

Such scheduling assumptions may alternatively be made directly in the table by utilizing an additional “new” (e.g., not used in legacy tables) column indicating if and/or what scheduling assumptions apply for each codepoint (i.e., for each row in the table). One example of this is illustrated in FIG. 22, where an additional column is added in the table. FIG. 22 depicts an example of rows in antenna port tables for rank 5 and single symbol DMRS for extended Rel-18 DMRS Type 1 for PDSCH, and where an additional row has been added indicating if other WDs might be co-scheduled with DMRS ports in the same CDM groups or not.

In this example, when a column entry is equal to “true” (i.e., rows with light shading), that indicates that other WDs 22 might be co-scheduled with DMRS ports belonging to one or both of the two CDM groups associated with that entry (i.e., for row X, other WDs 22 might be scheduled with DMRS port belonging to CDM group 0 and/or CDM group 1). When a row is equal to “false” (rows with dark shading), that indicates that no other WDs 22 are co-scheduled with DMRS ports belonging to one or both of the two CDM groups associated with that entry (i.e., for row X+1, no WDs 22 are co-scheduled with DMRS port belonging to CDM group 0 and/or CDM group 1).

In one embodiment, the indication is only applicable to CDM groups where only one or two legacy Rel-15 DMRS ports are used (i.e. if a CDM group only contain DMRS port 0 and/or DMRS port 1, which both are legacy DMRS Ports, the indication ‘false’ means that no other DMRS Ports will be co-scheduled in CDM group 0, however, if a CDM group consist of one or more new Rel-18 DMRS ports, e.g. if a CDM group contains DMRS port 12 and/or DMRS port 13, then even if the indication is ‘false’, the WD 22 cannot assume that no other DMRS ports are scheduled in that CDM group).

Based on this knowledge the WD 22 may adapt (i.e., update, configure, etc.) the receiver algorithm/configuration to improve the channel estimation quality, and hence the DL use throughput. In one embodiment, the same row may be used two times, where the only difference is that the new column has changed value from “true” to “false”.

In some embodiments, other values may be used, e.g., a “1” or “0”, to indicate if other WDs 22 are co-scheduled in the same CDM group or not. This method may be used for any number of PDSH layers down to single rank PDSCH transmission.

### Example Embodiments of Antenna Port Indication Tables for 6 PDSCH Layers

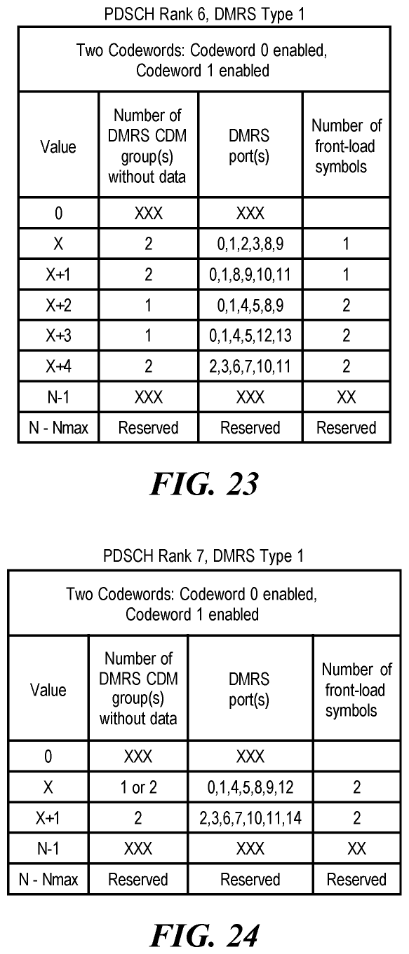

FIG. 23 depicts an example of rows in antenna port tables for rank 6 for extended Rel-18 DMRS Type 1, according to embodiments of the present disclosure.

In this example, the rows X to X+1 use a single (front loaded) DMRS symbol, and rows X+3 to X+5 is using two (front loaded) DMRS symbols.

In this example, in the row associated with codepoint value X and X+1 (single front loaded DMRS symbol), four DMRS ports are allocated to a first CDM group, and two DMRS ports are allocated to the second CDM group, and where the two DMRS ports in the second CDM group are mutually super orthogonal.

In this example, in the row associated with codepoint X+2 and X+3 (double front loaded DMRS symbol), only a single CDM group (CDM group 0) is used for all 6 DMRS ports, which reduce the number of CDM groups the WD has to perform channel estimation for (saving WD 22 complexity and/or WD 22 energy), as well as enabling the possibility to transmit PDSCH on REs associated with CDM group 1, which will increase the DL user throughput (i.e. when using only a single CDM group, PDSCH may be rate matched around the REs associated with the single CDM group, which gives more REs for PDSCH compared to if two CDM groups are used and the PDSCH must be rate-matched around both CDM groups).

In this example, in the row associated with codepoint X+4, all 6 ports are allocated to CDM group 1 instead of CDM group 0.

### Example Embodiments of Antenna Port Indication Tables for 7 PDSCH Layers

FIG. 24 depicts an example of rows in antenna port tables for rank 7 for extended Rel-18 DMRS Type 1, according to embodiments of the present disclosure.

In this example, in the row associated with codepoint X, only a single CDM group (CDM group 0) is used for all 7 DMRS ports, which reduce the number of CDM groups the WD 22 has to perform channel estimation for (saving WD 22 complexity and/or WD 22 energy), as well as enabling the possibility to transmit PDSCH on REs associated with CDM group 1, which will increase the DL user throughput (i.e. when using only a single CDM group, PDSCH may be rate matched around the REs associated with the single CDM group, which gives more REs for PDSCH compared to if two CDM groups are used and the PDSCH must be rate-matched around both CDM groups).

In this example, in the row associated with codepoint X+1, all 7 ports are allocated to CDM group 1 instead of CDM group 0.

### Example Embodiments on Antenna Port Indication Table for 8 PDSCH Layers

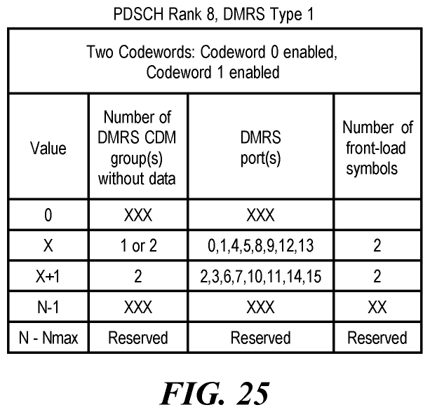

FIG. 25 illustrates some examples of rows in antenna port tables for rank 8 for extended Rel-18 DMRS Type 1, according to embodiments of the present disclosure.

In this example, in the row associated with codepoint X, only a single CDM group (CDM group 0) is used for all 8 DMRS ports, which reduce the number of CDM groups the WD 22 has to perform channel estimation for (saving WD 22 complexity and/or WD 22 energy), as well as enabling the possibility to transmit PDSCH on Res associated with CDM group 1, which will increase the DL user throughput (i.e. when using only a single CDM group, PDSCH may be rate matched around the Res associated with the single CDM group, which gives more Res for PDSCH compared to if two CDM groups are used and the PDSCH must be rate-matched around both CDM groups).

In this example, in the row associated with codepoint X+1, all 8 ports are allocated to CDM group 1 instead of CDM group 0.

Some embodiments may include one or more of the following.

Embodiment A1. A network node configured to communicate with a wireless device (WD), the network node configured to, and/or comprising a radio interface and/or comprising processing circuitry configured to:
determine a first indication corresponding to an antenna port field in downlink control signaling, the first indication indicating at least one of the following number of physical downlink share channel (PDSCH) layers:
   5 spatial layers;
   6 spatial layers;
   7 spatial layers; and
   8 spatial layers; and
cause transmission of the first indication to the WD, the first indication configured to cause the WD to receive reference signaling according to a demodulation reference signal (DMRS) port configuration, the DMRS port configuration being based on the first indication of the antenna port field.

Embodiment A2. The network node of Embodiment A1, wherein the network node is further configured to:
determine a second indication indicating at least one other WD is co-scheduled with DMRS ports belonging to at least one code division multiplexing (CDM) group associated with the DMRS ports indicated for the WD; and
cause transmission of the second indication to the WD.

Embodiment A3. The network node of any one of Embodiments A1 and A2, wherein, when the first indication indicates 5 spatial layers, the DMRS port configuration includes three DMRS ports being allocated to a first CDM group, and two DMRS ports being allocated to a second CDM group, the two DMRS ports in the second CDM group being mutually super orthogonal.

Embodiment A4. The network node of any one of Embodiments A1-A3, wherein, when the first indication indicates 6 spatial layers, the DMRS port configuration includes four DMRS ports being allocated to a first CDM group, and two DMRS ports being allocated to a second CDM group, the two DMRS ports in the second CDM group being mutually super orthogonal.

Embodiment A5. The network node of any one of Embodiments A1-A4, wherein a number of CDM groups associated with the DMRS port configuration is determined based on a frequency domain orthogonal cover code (FD-OCC) configuration combined with an time domain orthogonal cover code (TD-OCC) configuration for double symbol DMRS.

Embodiment B1. A method implemented in a network node, the method comprising:
determining a first indication corresponding to an antenna port field in downlink control signaling, the first indication indicating at least one of the following number of physical downlink shared channel (PDSCH) layers:
   5 spatial layers;
   6 spatial layers;
   7 spatial layers; and
   8 spatial layers; and
causing transmission of the first indication to the WD, the first indication configured to cause the WD to receive reference signaling according to a demodulation reference signal (DMRS) port configuration, the DMRS port configuration being based on the first indication of the antenna port field.

Embodiment B2. The method of Embodiment B1, wherein the method further comprises:
determining a second indication indicating at least one other WD is co-scheduled with DMRS ports belonging to at least one code division multiplexing (CDM) group associated with the DMRS ports indicated for the WD; and
causing transmission of the second indication to the WD.

Embodiment B3. The method of any one of Embodiments B1 and B2, wherein, when the first indication indicates 5 spatial layers, the DMRS port configuration includes three DMRS ports being allocated to a first CDM group, and two DMRS ports being allocated to a second CDM group, the two DMRS ports in the second CDM group being mutually super orthogonal.

Embodiment B4. The method of any one of Embodiments B1-B3, wherein, when the first indication indicates 6 spatial layers, the DMRS port configuration includes four DMRS ports being allocated to a first CDM group, and two DMRS ports being allocated to a second CDM group, the two DMRS ports in the second CDM group being mutually super orthogonal.

Embodiment B5. The method of any one of Embodiments B1-B4, wherein a number of CDM groups associated with the DMRS port configuration is determined based on a frequency domain orthogonal cover code (FD-OCC) configuration combined with an time domain orthogonal cover code (TD-OCC) configuration for double symbol DMRS.

Embodiment C1. A wireless device (WD) configured to communicate with a network node, the WD configured to, and/or comprising a radio interface and/or processing circuitry configured to:
receive, from the network node, a first indication corresponding to an antenna port field in downlink control signaling, the first indication indicating at least one of the following number of physical downlink share channel (PDSCH) layers:
   5 spatial layers;
   6 spatial layers;
   7 spatial layers; and
   8 spatial layers;
determine a demodulation reference signal (DMRS) port configuration based on the first indication of the antenna port field; and
receive reference signaling according to the DMRS port configuration.

Embodiment C2. The WD of Embodiment C1, wherein the WD is further configured to:
receive a second indication indicating at least one other WD is co-scheduled with DMRS ports belonging to at least one code division multiplexing (CDM) group associated with the DMRS ports indicated for the WD; and
the determining of the DMRS port configuration being further based on the second indication to the WD.

Embodiment C3. The WD of any one of Embodiments C1 and C2, wherein, when the first indication indicates 5 spatial layers, the DMRS port configuration includes three DMRS ports being allocated to a first CDM group, two DMRS ports being allocated to a second CDM group, and the two DMRS ports in the second CDM group being mutually super orthogonal.

Embodiment C4. The WD of any one of Embodiments C1-C3, wherein, when the first indication indicates 6 spatial layers, the DMRS port configuration includes four DMRS ports being allocated to a first CDM group, and two DMRS ports being allocated to a second CDM group, the two DMRS ports in the second CDM group being mutually super orthogonal.

Embodiment C5. The WD of any one of Embodiments C1-C4, wherein a number of CDM groups associated with the DMRS port configuration is determined based on a frequency domain orthogonal cover code (FD-OCC) configuration combined with an time domain orthogonal cover code (TD-OCC) configuration for double symbol DMRS.

Embodiment D1. A method implemented in a wireless device (WD), the method comprising:
receiving, from the network node, a first indication corresponding to an antenna port field in downlink control signaling, the first indication indicating at least one of the following number of physical downlink share channel (PDSCH) layers:
   5 spatial layers;
   6 spatial layers;
   7 spatial layers; and
   8 spatial layers;
determining a demodulation reference signal (DMRS) port configuration based on the first indication of the antenna port field; and
receive reference signaling according to the DMRS port configuration.

Embodiment D2. The method of Embodiment D1, wherein the method further comprises:
receiving a second indication indicating at least one other WD is co-scheduled with DMRS ports belonging to at least one code division multiplexing (CDM) group associated with the DMRS ports indicated for the WD; and
the determining of the DMRS port configuration being further based on the second indication to the WD.

Embodiment D3. The method of any one of Embodiments D1 and D2, wherein, when the first indication indicates 5 spatial layers, the DMRS port configuration includes three DMRS ports being allocated to a first CDM group, and two DMRS ports being allocated to a second CDM group, the two DMRS ports in the second CDM group being mutually super orthogonal.

Embodiment D4. The method of any one of Embodiments D1-D3, wherein, when the first indication indicates 6 spatial layers, the DMRS port configuration includes four DMRS ports being allocated to a first CDM group, and two DMRS ports being allocated to a second CDM group, the two DMRS ports in the second CDM group being mutually super orthogonal.

Embodiment D5. The method of any one of Embodiments D1-D4, wherein a number of CDM groups associated with the DMRS port configuration is determined based on a frequency domain orthogonal cover code (FD-OCC) configuration combined with an time domain orthogonal cover code (TD-OCC) configuration for double symbol DMRS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-18. (canceled)

19. A method in a wireless device (WD) configured to communicate with a network node, the method comprising:
receiving, from the network node, a downlink control information (DCI) message scheduling a physical downlink shared channel, the DCI comprising an antenna port field indicating one of 5, 6, 7, and 8 physical downlink shared channel (PDSCH) layers and an allocation of demodulation reference signal (DMRS) ports to one and the same code division multiplexing;
determining a DMRS port configuration based at least in part on the antenna port field; and
receiving DMRS signaling according to the determined DMRS port configuration.

20.-22. (canceled)

23. The method of claim 19, wherein, when the indication indicates 5 PDSCH layers, three of the PDSCH layers are allocated to a first time domain orthogonal cover (TD-OCC) code, and two of the PDSCH layers are allocated to a second TD-OCC code, the two DMRS ports in the second TD-OCC code being mutually super-orthogonal.

24. The method of claim 19, wherein a number of CDM groups associated with the DMRS port configuration is determined based on a frequency domain orthogonal cover code (FD-OCC) configuration combined with a time domain orthogonal cover code (TD-OCC) configuration for double symbol DMRS.

25. A wireless device (WD) configured to communicate with a network node, the WD configured to:
receive, from the network node, a downlink control information (DCI) message scheduling a physical downlink shared channel (PDSCH), the DCI comprising an antenna port field indicating one of 5, 6, 7, and 8 PDSCH layers and an allocation of demodulation reference signal (DMRS) ports to one and the same code division multiplexing (CDM) group;
determine a DMRS port configuration based at least in part on the antenna port field; and
receive DMRS signaling according to the determined DMRS port configuration.

26. The WD of claim 25, wherein, when the antenna port field indicates 5 PDSCH layers, three of the PDSCH layers are allocated to a first time domain orthogonal cover (TD-OCC) code, and two of the PDSCH layers are allocated to a second TD-OCC code, the two DMRS ports in the second TD-OCC code being mutually super-orthogonal.

27. The WD of claim 25, wherein a number of CDM groups associated with a DMRS port configuration is determined based on a frequency domain orthogonal cover code (FD-OCC) configuration combined with a time domain orthogonal cover code (TD-OCC) configuration for double symbol DMRS.

28. A method in a network node configured to communicate with a wireless device, WD, the method comprising:
determining an antenna port field of a downlink control information (DCI) message associated with a demodulation reference signal (DMRS) port configuration, the DCI scheduling a physical downlink shared channel (PDSCH), the antenna port field indicating one of 5, 6, 7, and 8 PDSCH layers and an allocation of DMRS ports to one and the same code division multiplexing (CDM) group;
transmitting the DCI message to the WD; and
transmitting DMRS signaling according to the DMRS port configuration.

29. The method of claim 28, wherein, when the antenna port field indicates 5 PDSCH layers, three of the PDSCH layers are allocated to a first time domain orthogonal cover code (TD-OCC) code, and two of the PDSCH layers are allocated to a second TD-OCC code, the two DMRS ports in the second TD-OCC code being mutually super-orthogonal.

30. The method of claim 28, wherein a number of CDM groups associated with the DMRS port configuration is determined based on a frequency domain orthogonal cover code (FD-OCC) configuration combined with a time domain orthogonal cover code (TD-OCC) configuration for double symbol DMRS.

31. A network node configured to communicate with a first wireless device, WD, the network node configured to:
determine an antenna port field of a downlink control information (DCI) message associated with a demodulation reference signal (DMRS) port configuration, the DCI scheduling a physical downlink shared channel (PDSCH), the antenna port field indicating one of 5, 6, 7, and 8 PDSCH layers and an allocation of DMRS ports to one and the same code division multiplexing (CDM) group;
transmit the DCI message to the WD; and
transmit DMRS signaling according to the DMRS port configuration.

32. The network node of claim 31, wherein, when the antenna port field indicates 5 PDSCH layers, three of the PDSCH layers are allocated to a first time domain orthogonal cover code (TD-OCC) code, and two of the PDSCH layers are allocated to a second TD-OCC code, the two DMRS ports in the second TD-OCC code being mutually super-orthogonal.

33. The network node of claim 31, wherein a number of CDM groups associated with the DMRS port configuration is determined WD a frequency domain orthogonal cover code (FD-OCC) configuration combined with a time domain orthogonal cover code (TD-OCC) configuration for double symbol DMRS.
